(19) United States
(12) Patent Application Publication
(10) Pub. No.: US 2021/0389710 A1
(43) Pub. Date: Dec. 16, 2021

(54) IMAGE FORMING DEVICE

(71) Applicant: Konica Minolta, Inc., Tokyo (JP)

(72) Inventor: Toru KIKUCHI, Tokyo (JP)

(21) Appl. No.: 17/321,375

(22) Filed: May 14, 2021

(30) Foreign Application Priority Data
Jun. 12, 2020 (JP) 2020-101954

(51) Int. Cl. G03G 15/00

(52) U.S. Cl. CPC G03G 15/5029; G03G 15/6529

(57) ABSTRACT

An image forming device includes an image carrier, a transfer member, a fixing device, a conveyance member, and a controller. The transfer member forms a transfer nip that transfers an image carried on the image carrier to a recording medium. The fixing device fixes the image on the recording medium. The conveyance member is located downstream of the transfer member in a conveyance direction of the recording medium and feeds the recording medium to the fixing device. The controller variably controls position of the conveyance member.

### BACKGROUND

### 1. Technical Field

The present invention relates to an image forming device.

### 2. Background Art

In an image forming device, a toner image carried on an intermediate transfer belt or the like is transferred to a recording medium. The recording medium is fed into a fixing nip of a fixing device.

At this time, the recording medium is distorted because the recording medium gets into the fixing nip at an angle. The recording medium comes into contact with an upper fixing member (belt, upper guide, etc.), and thereby streak-like wrinkles (blur) are generated at an edge of the recording medium.

According to an invention described in JP 2011-253019A, both sides of paper are passed through a device. A voltage applied to a secondary transfer roller is higher when the second side is passed than when the first side is passed. The secondary transfer roller is moved away from a fixing device to convey the paper. It stabilizes entry into a fixing nip.

According to an invention described in JP 2019-86586A, both sides of paper are passed through a device. An amount of curl is detected when the second side gets into a fixing approach guide. Paper is conveyed while position and shape of the guide are changed according to condition of paper. It stabilizes entry into a fixing nip.

However, position where paper is conveyed to the fixing device becomes unstable depending on stiffness of a recording medium such as thin paper. Sometimes a recording medium diagonally gets into the fixing nip to cause a blur. Even if conveyance position is optimized for a recording medium of a certain stiffness, position where paper is conveyed to the fixing device becomes unstable when a recording medium of different stiffness is conveyed. Sometimes a recording medium diagonally gets into the fixing nip to cause a blur.

### SUMMARY OF INVENTION

The present invention was made in view of the above problems in the prior art. An object of the present invention is to maintain good image quality by stably conveying a recording medium to a fixing device in an image forming device without changing transcription of an image to the recording medium.

According to an aspect of the present invention, an image forming device includes:

an image carrier;

a transfer member that forms a transfer nip that transfers an image carried on the image carrier to a recording medium;

a fixing device that fixes the image on the recording medium;

a conveyance member which is located downstream of the transfer member in a conveyance direction of the recording medium and which feeds the recording medium to the fixing device; and

a controller,

wherein the controller variably controls position of the conveyance member.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic view showing main configuration of a transfer unit for a recording medium and a fixing device.

FIG. 2 is a block diagram showing main functional configuration of an image forming device.

FIG. 3 is a schematic view showing main configuration of the transfer unit for a recording medium and the fixing device for explaining a distance detector.

FIG. 4 is a cross-sectional view and a plan view of a recording medium for explaining the distance detector.

FIG. 5 is a schematic view showing main configuration of the transfer unit for a recording medium and the fixing device for explaining a degree of separation of a recording medium.

FIG. 6 is a table of correspondence between conditions applied by a controller and height of a conveyance member.

FIG. 7 is a table of correspondence between conditions applied by the controller and height of the conveyance member.

FIG. 8 is a two-dimensional graph of temperature and humidity. Environment is divided into three parts.

FIG. 9 is a table of correspondence between conditions applied by the controller and height of the conveyance member.

FIG. 10 is a table of correspondence between conditions applied by the controller and height of the conveyance member.

FIG. 11 is a schematic view showing positional relation between a recording medium and the conveyance member and a fixing nip.

FIG. 12 is a schematic view showing positional relation between a recording medium and the conveyance member and the fixing nip.

### DESCRIPTION OF EMBODIMENTS

An embodiment of the present invention will be described below with reference to the drawings. The following is one embodiment of the present invention and does not limit the present invention.

The embodiment is an electrophotographic image forming device including configuration described below.

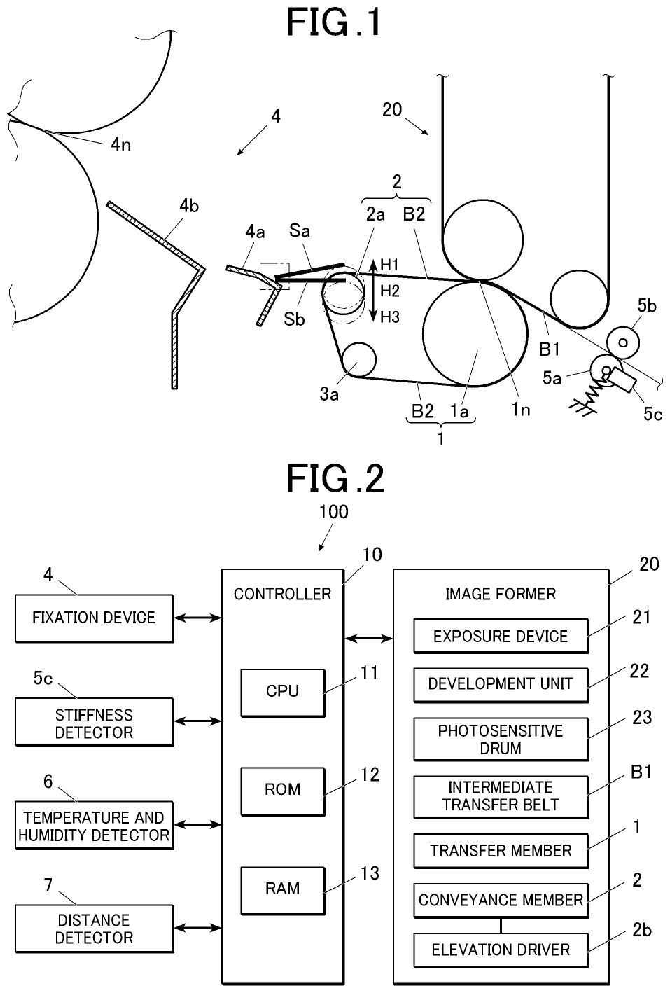

FIG. 1 is a schematic view showing main configuration of a transfer unit for a recording medium (paper) and a fixing device in the image forming device of the embodiment. FIG. 2 is a block diagram showing main functional configuration of the image forming device of the embodiment.

The image forming device 100 of the embodiment includes a controller 10, an image former 20, a fixing device 4, a stiffness detector 5c, a temperature and humidity detector 6, and a distance detector 7.

The controller 10 of the image forming device 100 controls the entire image forming device 100 including the image former 20 and the fixing device 4.

The controller 10 includes a CPU (central processing unit) 11, ROM (read only memory) 12, and RAM (random access memory) 13. The CPU 11 reads a program corresponding to contents of processing from the ROM 12 and develops it in the RAM 13. The CPU 11 cooperates with the developed program to comprehensively control operation of parts of the image forming device 100.

The electrophotographic image former 20 includes:

an exposure device 21 that draws an electrostatic latent image on a photosensitive drum 23;

a development unit 22 that develops the electrostatic latent image into a toner image;

an intermediate transfer belt B1 as an image carrier on which a toner image is transferred from the photosensitive drum 23;

a transfer member 1 (1a and B2) that forms a transfer nip 1n that transfers (secondary transfer) the toner image carried on the intermediate transfer belt B1 to a recording medium S (Sa, Sb);

a conveyance member 2 (2a and B2) which is located downstream from the transfer member 1 in a conveyance direction of the recording medium S and which feeds the recording medium S to the fixing device 4; and

other common configurations such as a charging device and a cleaning device.

The image forming device 100 further includes an image reader, an operation display, an image processor that processes image data, a paper conveyor (including resist rollers 5a, 5b), a memory, and a communicator.

The transfer member 1 includes a transfer roller 1a and a conveyance belt B2 hung on the transfer roller 1a. The conveyance member 2 includes a drive roller 2a and the conveyance belt B2. The transfer member 1 and the conveyance member 2 share the conveyance belt B2.

The conveyance belt B2 circulates between:

a position where the conveyance belt B2 functions as the transfer member 1; and

a position where the conveyance belt B2 functions as the conveyance member 2.

The conveyance belt B2 functions as the transfer member 1 at the transfer nip 1n. The conveyance belt B2 functions as the conveyance member 2 in a range between the transfer nip 1n and the drive roller 2a downstream from the transfer nip 1n.

The conveyance belt B2 is wound around the transfer roller 1a, the drive roller 2a, and a tension pulley 3a. The conveyance belt B2 is driven by rotation of the drive roller 2a.

The conveyance member 2 is moved up and down by an elevation driver 2b. Both ends of a shaft of the drive roller 2a are moved up and down together. Alternatively, each end of the shaft of the drive roller 2a is moved up and down individually. Thereby an upper surface of the conveyance belt B2 also moves up and down. The upper surface of the conveyance belt B2 is at a position where the conveyance belt B2 functions as the conveyance member 2. In the configuration in which each end of the shaft of the drive roller 2a is moved up and down individually, the controller 10 individually controls position (height) of each edge of the conveyance member 2 in a width direction FR of the recording medium S, which is orthogonal to the conveyance direction of the recording medium S.

The controller 10 outputs a control signal to the elevation driver 2b to variably control position of the conveyance member 2. In the embodiment, height levels in control are H1, H2, and H3 in descending order as shown in FIG. 1. As described above, displacement of the conveyance member 2 caused by control of the controller 10 includes a component perpendicular to a surface of the recording medium S passing through the conveyance member 2. The displacement is not limited to a vertical displacement. The displacement compensates for variations in separation of the recording medium S from the conveyance member 2. As a result, the displacement keeps conveyance position on the fixing device 4 within a certain range.

As described above, the conveyance member 2 is a rotating member and conveys at least the recording medium S. The conveyance member 2 may be just a conveyance roller, or may be a conveyance belt independent of the transfer member.

Two fixing guide members of the fixing device 4, i.e., a pre-fixing guide 4a and a fixing approach guide 4b, guide the recording medium S and put the recording medium S into a fixing nip 4n. The fixing guide members may be integrated.

The stiffness detector 5c is a kind of physical property detector that detects physical properties of the recording medium S. The stiffness detector 5c detects stiffness of the recording medium S. For example, the stiffness detector 5c is an acceleration sensor. The resist roller 5a is supported by a spring as shown in FIG. 1. The acceleration sensor detects vibration of the resist roller 5a when the recording medium S collides.

The stiffness detector 5c measures stiffness of the recording medium S beginning to be conveyed to the transfer nip 1n. Thus, the stiffness detector 5c individually detects stiffness of each recording medium S on which an image is formed.

The stiffness detector 5c detects stiffness of the recording medium S before the recording medium S reaches the conveyance member 2. Therefore, the controller 10 can control height of the conveyance member 2 before the recording medium S reaches the conveyance member 2.

The temperature and humidity detector 6 detects temperature and humidity of environment around the recording medium S.

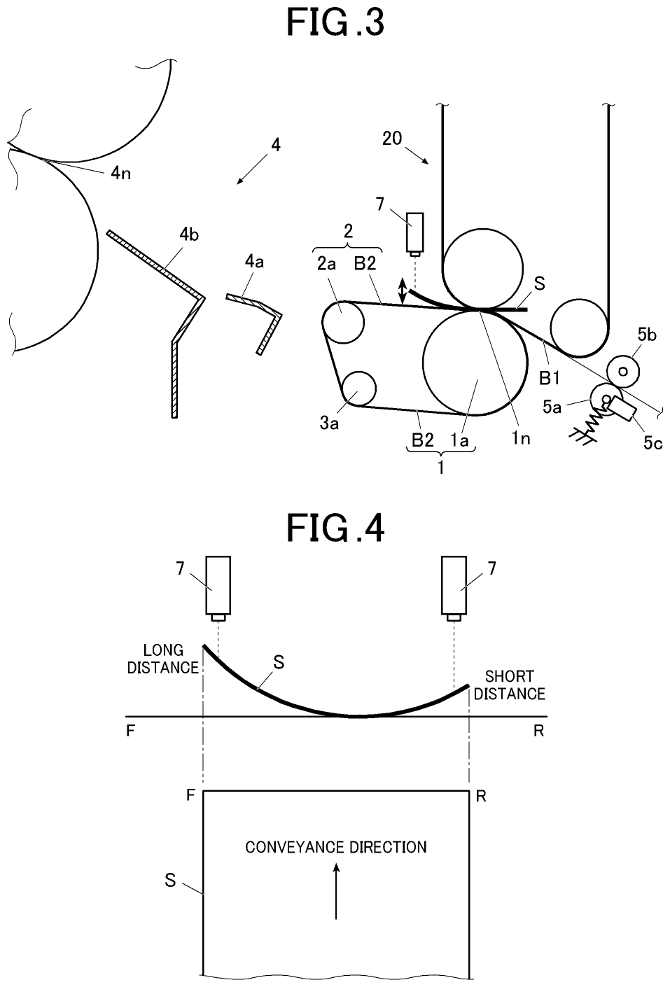

The distance detector 7 is located upstream of the conveyance member 2 and detects a distance between the recording medium S and the conveyance belt B2. The distance detector 7 is, for example, an optical distance sensor. As shown in FIG. 3, the distance detector 7 detects a distance between the recording medium S and the conveyance belt B2 downstream of the transfer nip 1n. A measured value obtained by measuring a surface of the conveyance belt B2 in the absence of the recording medium S may be used as a reference for the distance.

As shown in FIG. 4, the distance detector 7 may detect a distance between the recording medium S and the conveyance belt B2 at two or more different positions in the width direction FR of the recording medium S, which is orthogonal to the conveyance direction of the recording medium S. In FIG. 4, distances at two points are measured, but distances at three or more points may be measured.

A flow of operation is as follows.

A tip of the recording medium S hits the resist rollers 5a, 5b, and the recording medium S temporarily stops. The recording medium S passes through the resist rollers 5a, 5b to get into the transfer nip 1n at the same predetermined time as time of image feed of the intermediate transfer belt B1.

As the recording medium S passes through the transfer nip 1n, a toner image carried on the intermediate transfer belt B1 is transferred to the recording medium S.

The recording medium S on which the toner image is transferred is fed to the fixing device 4 by the conveyance member 2. The recording medium S first hits the pre-fixing guide 4a. The recording medium S is guided by the pre-fixing guide 4a and the fixing approach guide 4b, and gets into the fixing nip 4n.

Before the recording medium S hits the pre-fixing guide 4a, when the recording medium S is fed to the fixing device 4 by the conveyance member 2, the controller 10 controls the conveyance member 2 such that the conveyance member 2 is at an appropriate height. The controller 10 brings the recording medium S into contact with the pre-fixing guide 4a at an appropriate angle, and smoothly feeds the recording medium S to the fixing device 4.

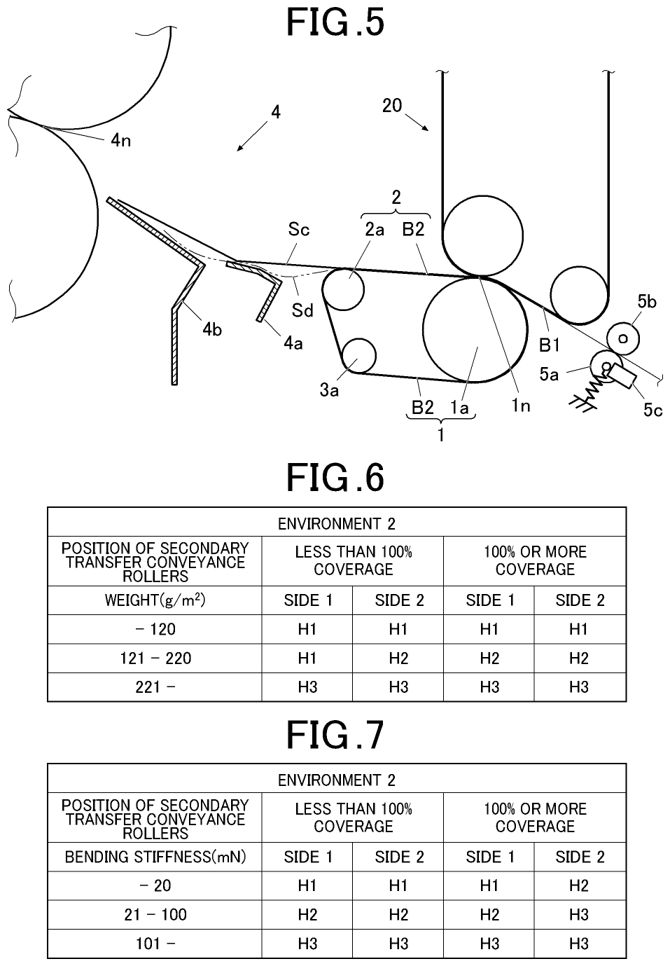

As shown in FIG. 5, the recording medium S is separated from the conveyance belt B2 due to curvature of the drive roller 2a and stiffness of the recording medium S. Degree of separation depends on stiffness of the recording medium S. Therefore, a point where the recording medium S lands on the pre-fixing guide 4a from the conveyance belt B2 varies depending on basis weight and the like. Even if height is adjusted for a recording medium Sc of a certain stiffness, a recording medium Sd of a different stiffness sometimes lands unstably on the pre-fixing guide 4a and diagonally gets into the fixing nip 4n. It causes a blur.

Therefore, height of the conveyance member 2 is changed according to conditions, such as physical properties of the recording medium S, by variable control of the controller 10. That is, the controller 10 controls position of the conveyance member 2 according to physical properties of the recording medium S fed to the fixing device 4 by the conveyance member 2. It stabilizes the point where the recording medium S lands on the pre-fixing guide 4a. The recording medium S is conveyed from the pre-fixing guide 4a along the fixing approach guide 4b, and smoothly gets into the fixing nip 4n. It maintains good image quality.

The following is an example of control of position of the conveyance member 2 by the controller 10.

### Control Example 1

First, Control Example 1 will be described.

The controller 10 selects a height of the conveyance member 2 from H1-H3 based on difference in basis weight of the recording medium S, coverage of a formed image, and single/double-sided printing.

In terms of coverage, the stiffness increases by a thickness of toner. In double-sided printing, the stiffness is increased once the recording medium S passes through the fixing nip 1n. Since the stiffness changes as described above, the point where the recording medium S lands on the pre-fixing guide 4a varies. The controller 10 variably controls the conveyance member 2 according to conditions such that the conveyance member 2 is at an appropriate position. Thereby the controller 10 stabilizes the point where the recording medium S lands on the pre-fixing guide 4a.

FIG. 6 and FIG. 7 are tables of correspondence between conditions applied by the controller 10 and height of the conveyance member 2. In FIG. 6, basis weight, coverage, and side 1/2 are condition items. The side 1 represents printing on the first side. The side 2 represents printing on the second side in double-sided printing. In FIG. 7, bending stiffness detected by the stiffness detector 5c is applied as a condition instead of the basis weight. Others are the same condition items as those in FIG. 6.

The controller 10 selects a height of the conveyance member 2 from H1-H3 according to the correspondence table in FIG. 6 or FIG. 7. It stabilizes the point where the recording medium S lands on the pre-fixing guide 4a. The recording medium S is conveyed from the pre-fixing guide 4a along the fixing approach guide 4b, and smoothly gets into the fixing nip 4n. It maintains good image quality.

### Control Example 2

Control Example 2 is performed in addition to Control Example 1.

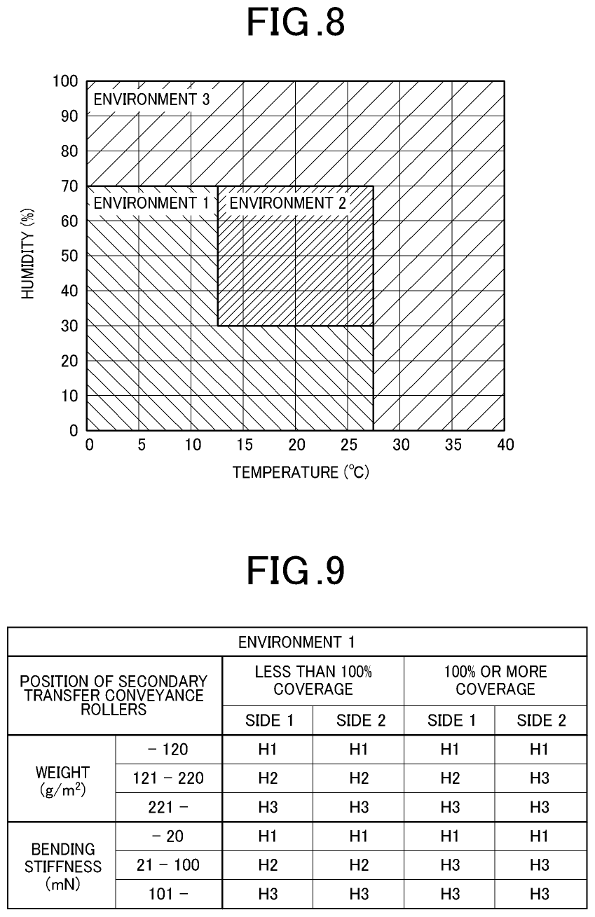

Since stiffness of the recording medium S varies depending on temperature and humidity, posture of the recording medium S getting into the fixing device 4 also varies. As shown in FIG. 8, an area on a two-dimensional graph of temperature and humidity is divided into three environments.

The controller 10 controls position of the conveyance member 2 as follows based on values detected by the temperature and humidity detector 6.

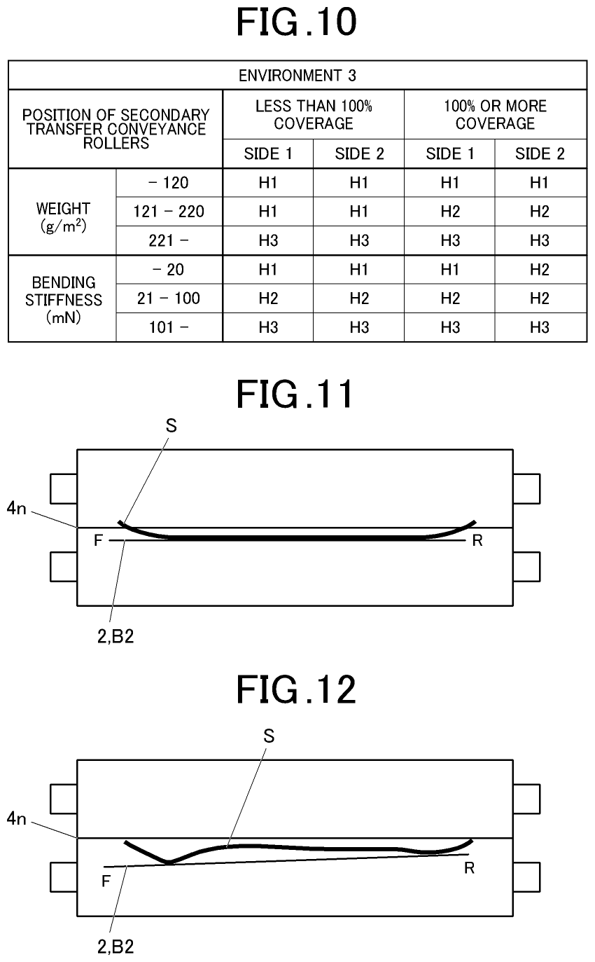

In a case where the temperature and humidity detected by the temperature and humidity detector 6 correspond to Environment 2, the controller 10 applies the correspondence table in FIG. 6 or FIG. 7. In a case where temperature and humidity correspond to Environment 1, the controller 10 applies a correspondence table in FIG. 9. In a case where temperature and humidity correspond to Environment 3, the controller 10 applies a correspondence table in FIG. 10. Thus, the controller 10 selects a height of the conveyance member 2.

The point where the recording medium S lands on the pre-fixing guide 4a is stabilized even if temperature and humidity change. The recording medium S is conveyed from the pre-fixing guide 4a along the fixing approach guide 4b, and smoothly gets into the fixing nip 4n. It maintains good image quality.

### Control Example 3

Control example 3 will be described.

The controller 10 controls position of the conveyance member 2 based on values detected by the distance detector 7. Specifically, the larger the distance, the lower the position of the conveyance member 2 which is set by the controller 10. It stabilizes the point where the recording medium S lands on the pre-fixing guide 4a. The recording medium S is conveyed from the pre-fixing guide 4a along the fixing approach guide 4b, and smoothly gets into the fixing nip 4n. It maintains good image quality.

FIG. 11 shows a case where distances between the recording medium S and the conveyance belt B2 at both edges of the conveyance member 2 are substantially the same. The controller 10 moves up and down the conveyance member 2 in a state where the conveyance member 2 is parallel to the fixing nip 4n.

FIG. 12 shows a case where distances between the recording medium S and the conveyance belt B2 at both edges of the conveyance member 2 are different. The controller 10 individually controls position of each edge of the conveyance member in the width direction FR of the recording medium based on values detected by the distance detector 7. Specifically, the conveyance member 2 is tilted with respect to the fixing nip 4n and the height is appropriately controlled so that imbalance of positions of both edges with respect to the fixing nip 4n is reduced. In FIG. 12, one edge F is lower than another edge R. Even in a case where distances between the recording medium S and the conveyance belt B2 at right and left edges of the conveyance member 2 are different, the point where the recording medium S lands on the pre-fixing guide 4a is stabilized. The recording medium S is conveyed from the pre-fixing guide 4a along the fixing approach guide 4b, and smoothly gets into the fixing nip 4n. It maintains good image quality.

As described above, shape of the transfer nip to is maintained even if position of the conveyance member 2 changes. Transcription of an image to a recording medium does not change. Therefore, conveyance to the fixing device 4 is stabilized without changing transcription of an image to a recording medium. Good image quality is maintained

The scope of the present invention is not limited to the above embodiment, and includes various modifications, omission, and combinations within the scope of the claims of the present invention.

In the above control for position, control values may be calculated based on values detected by detectors. Alternatively, a table showing relation between detected values and control values may be prepared in advance. A control value is determined by referring to the table based on a detected value.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2020-101954, filed on Jun. 12, 2020, is incorporated herein by reference in its entirety.

What is claimed is:

1. An image forming device, comprising:
an image carrier;
a transfer member that forms a transfer nip that transfers an image carried on the image carrier to a recording medium;
a fixing device that fixes the image on the recording medium;
a conveyance member which is located downstream of the transfer member in a conveyance direction of the recording medium and which feeds the recording medium to the fixing device; and
a controller,
wherein the controller variably controls position of the conveyance member.

2. The image forming device according to claim 1, wherein the controller controls the position of the conveyance member according to physical properties of the recording medium fed to the fixing device by the conveyance member.

3. The image forming device according to claim 2, further comprising:
a physical property detector that detects the physical properties of the recording medium.

4. The image forming device according to claim 1, wherein displacement of the conveyance member caused by control of the controller includes a component perpendicular to a surface of the recording medium passing through the conveyance member.

5. The image forming device according to claim 1, further comprising:
a temperature and humidity detector that detects temperature and humidity,
wherein the controller controls the position of the conveyance member based on values detected by the temperature and humidity detector.

6. The image forming device according to claim 1, wherein the controller individually controls position of each edge of the conveyance member in a width direction of the recording medium which is orthogonal to the conveyance direction of the recording medium.

7. The image forming device according to claim 1, further comprising:
a distance detector which is located upstream of the conveyance member and which detects a distance between the recording medium and the conveyance member,
wherein the controller controls the position of the conveyance member based on values detected by the distance detector.

8. The image forming device according to claim 7, wherein
the distance detector detects distances between the recording medium and the conveyance member at two or more different positions in the width direction of the recording medium which is orthogonal to the conveyance direction of the recording medium, and
the controller individually controls position of each edge of the conveyance member in the width direction of the recording medium based on the values detected by the distance detector.

9. The image forming device according to claim 1, wherein the conveyance member is a rotating member.

10. The image forming device according to claim 1, wherein the transfer member and the conveyance member share a conveyance belt.
